(19) United States
(12) Patent Application Publication
(10) Pub. No.: US 2015/0042061 A1
(43) Pub. Date: Feb. 12, 2015

(54) Pedal propulsion system with lowered pedals

(71) Applicant: Shane Chen, Camas, WA (US)

(72) Inventor: Shane Chen, Camas, WA (US)

(21) Appl. No.: 13/964,105

(22) Filed: Aug. 11, 2013

(51) Int. Cl. B62M 1/38; B62K 1/00

(52) U.S. Cl. CPC B62M 1/38; B62K 1/00
USPC 280/205

(57) ABSTRACT

A rotary pedal system for propelling a one-wheeled vehicle, in which the pedals are disposed at a distance from their respective pivot shafts. The pivot shafts are pivotably independently of the rotation of the wheel, so that the pedals tend to remain downwardly displaced from their respective pivot shaft while in use. The lowered pedals increase the ease of riding, mounting, and dismounting the one wheeled vehicle, in both seated and standing embodiments.

### FIELD OF THE INVENTION

The present invention relates to rotary pedal propulsion systems for wheeled vehicles, particularly one-wheeled vehicles.

### BACKGROUND OF THE INVENTION

Rotary pedal is the most common system for propelling human-powered wheeled vehicles, including unicycles. Most seated unicycles use a simple pedal system in which the left and right sides of the wheel each have a crank coupled directly to an end of the wheel's axle, and a pedal body which is rotatably coupled to the crank. Unicycles designed to be ridden by standing users are of even simpler construction, with the pedals rotatably coupled to some part of the wheel itself. Most unicycle pedal systems do not include gears; instead, unicycles are available in a wide range of wheel sizes for different applications.

A large wheel provides the advantages of moving at higher speeds and traveling longer distances efficiently. However, a large-diameter wheel results in the pedals being higher from the ground, which causes greater difficulty of riding and especially of mounting and dismounting. It also increases the dangers associated with falling. This is the case for both seated and standing versions. A need therefore exists for a unicycle pedal system in which the center of the pedals' rotation is lower than the center of the wheel, which preserving mechanical simplicity.

### SUMMARY

The unicycle pedal system of the present invention has novel pedal assemblies in which the center of rotation of the pedals is below the center of the wheel. Each pedal assembly comprises a pedal body coupled to a connecting member, which is in turn coupled to a pivot shaft, creating an offset between the pedal body and the pivot shaft. Since the rotation of the pivot shaft is independent of the rotation of the wheel, the pedal body tends to remain lower than the axis of the pivot shaft while downward force is being applied.

When the pedal system of the present invention is used on a unicycle without a seat, the left and right pedal assemblies may be coupled to some part of the wheel's structural frame. When the pedal system is implemented on a seated unicycle, the pedal assemblies may be coupled to crank arms which drive the wheel's axle.

### BRIEF DESCRIPTION OF THE DRAWINGS

FIG. 1 shows a perspective view of an embodiment of the pedal system of the present invention.

FIG. 2 shows a perspective view of a one-wheeled vehicle having the pedal system of FIG. 1.

FIG. 3 shows a side view of the one-wheeled vehicle of FIG. 2.

FIG. 4 shows a side view of another one-wheeled vehicle having the pedal system of the present invention.

### DETAILED DESCRIPTION

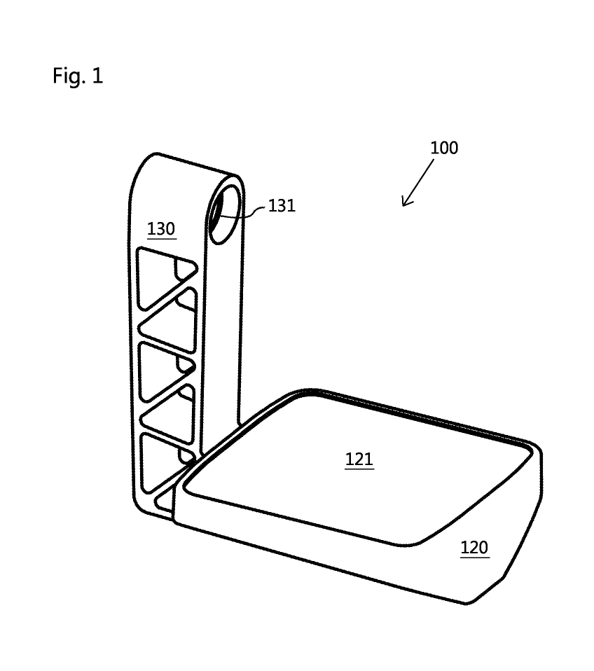

FIG. 1 shows one embodiment of a pedal assembly 100 according to the present invention. Pedal assembly 100 comprises a pedal body 120, a connecting member 130 to which pedal body 120 is coupled, and a pivot shaft 131 coupled to connecting member 130 whereby the entire pedal assembly 100 can pivot. Pedal body 120 bears a foot support surface 121 upon which the user's foot can exert force in order to propel the vehicle. Connecting member 130 may be a short elongated member having two ends, one of which is rigidly coupled to the side of pedal body 120 closest to the wheel. The other end of connecting member 130 is coupled to pivot shaft 131. This arrangement offsets foot support surface 121 at a distance from the pivot point of the pedal assembly, in contrast to conventional pedal systems in which the pivot shaft is coupled directly to the pedal body and the foot support surface is level or nearly level with the axis of the pivot shaft.

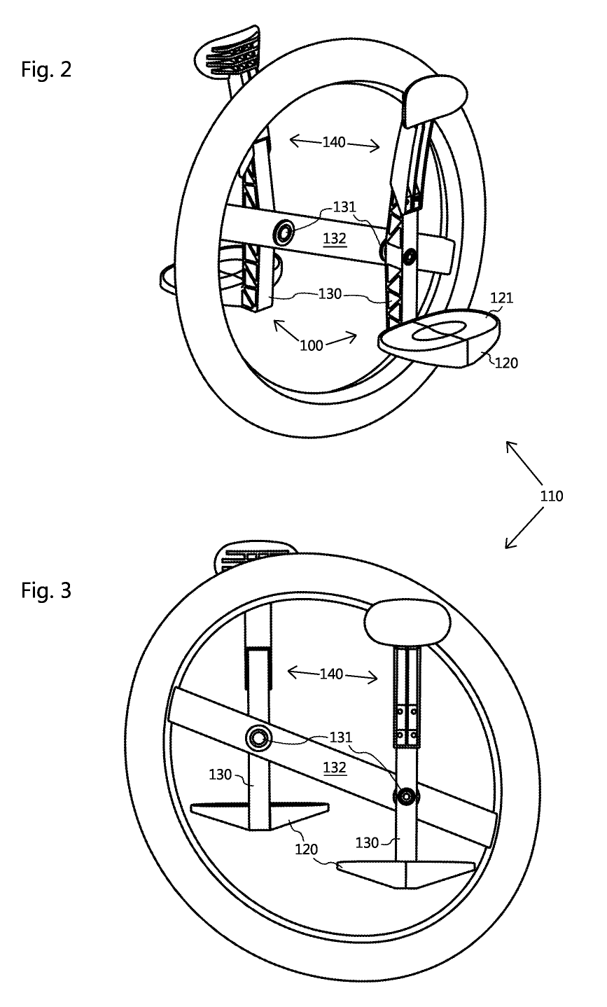

FIGS. 2 and 3 show an embodiment of a one-wheeled vehicle 110 having the pedal system of the present invention, consisting of left and right pedal assemblies 100. Vehicle 110 is a unicycle designed to be ridden by a standing user. In this embodiment, the wheel has a rigid frame bar 132 which crosses the diameter of the wheel. Pivot shaft 131 is coupled to frame bar 132 at a radial distance from the center of the wheel, and each pivot shaft 131 has a pivoting axis substantially perpendicular to the plane of the wheel. When pedal assembly 100 is in use, the user exerts a generally downward force upon foot support surface 121 for propelling the vehicle and for supporting the user's weight. Since the rotation of pivot shaft 131 is independent of the rotation of the wheel, pedal body 120 tends to remain closer to the ground than pivot shaft 131 throughout the pedaling cycle. The magnitude of the offset between foot support surface 121 and pivot shaft 131 may be approximately the height of the user's ankle. The lowered pedals and the resultantly lower center of gravity of the user increase the ease and stability of riding the vehicle, make dismounts (both planned and unplanned) safer and more comfortable, and increase the convenience of mounting the vehicle.

This embodiment additionally includes leg stabilizing apparatuses 140, the upper portions of which contact the inward-facing sides of the user's legs. Leg stabilizing apparatuses 140 are not a necessary part of the present invention, but if present, may comprise elongated members which share pivot shafts 131 with connecting members 130.

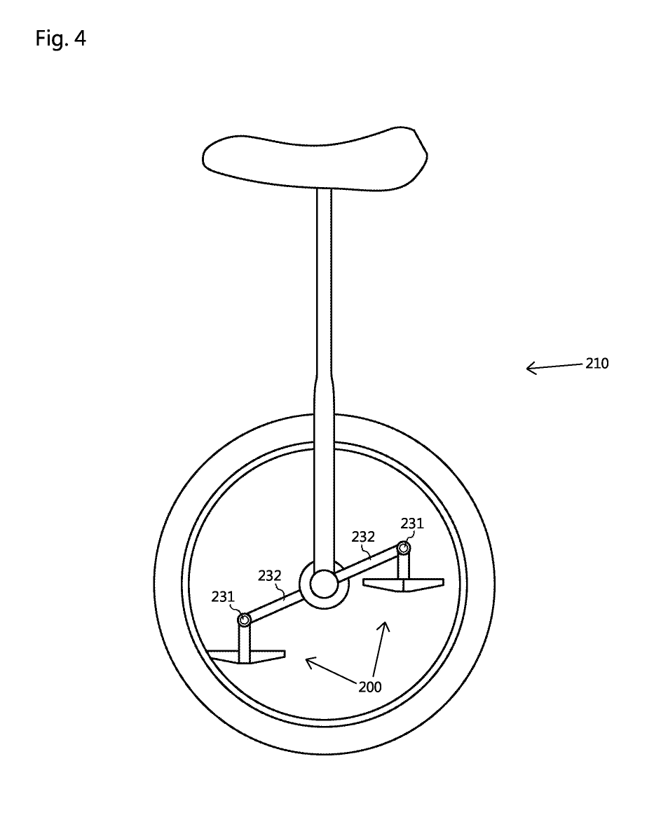

FIG. 4 shows a one-wheeled vehicle 210 having a pedal assembly 200 according to the present invention. (The wheel is shown without spokes for clarity.) As in conventional seated unicycles, vehicle 210 has a seat supported by a seat post and a fork coupled to both sides of the wheel's axle. Pedal assembly 200 comprises a pedal body 220, a connecting member 230, and a pivot shaft 231, all configured in the same way as in pedal assembly 100 of FIGS. 1-3. However, in this embodiment, pivot shaft 231 is coupled to a crank arm 232 instead of to the wheel itself. Crank arm 232 is a rigid elongated member extending radially from the center of the wheel, coupled at one end to pedal assembly 200 and at the other end to the axle of the wheel.

1. A pedal system for propelling a one-wheeled vehicle upon a riding surface, comprising a left pedal assembly and a right pedal assembly, each of said pedal assemblies comprising:
a pivot shaft having an axis which intersects the plane of said wheel at a radius from the center of said wheel; and
a pedal having a foot support surface, said pedal being capable of pivoting about said pivot shaft;
wherein said foot support surface is disposed at a distance from said pivot shaft, such that said foot support surface tends to remain closer than said axis of said pivot shaft to the riding surface when said pedal is in use.

2. The pedal system of claim 1, wherein said pivot shaft is coupled to said wheel.

3. The pedal system of claim 1, further comprising a crank arm having a first end coupled to said wheel and a second end coupled to said pivot shaft.

4. The pedal system of claim 1, wherein said distance between said foot support surface and said pivot shaft is comparable to the height of a user's ankle.

5. The pedal system of claim 1, wherein said vehicle has only one wheel.

6. The pedal system of claim 5, wherein said one-wheeled vehicle has a seat.

7. The pedal system of claim 5, wherein said one-wheeled vehicle is designed to be ridden by a standing user.

8. A pedal system for propelling a one-wheeled vehicle upon a riding surface, comprising a left pedal assembly and a right pedal assembly, each of said pedal assemblies comprising:
a pivot shaft having an axis which intersects the plane of said wheel at a radius from the center of said wheel;
a connecting member coupled to said pivot shaft so as to be pivotable independently of the rotation of said wheel; and
a pedal rigidly coupled to said connecting member such that said pedal is disposed at a distance from said pivot shaft, said pedal having a foot support surface.

9. The pedal system of claim 8, wherein said pivot shaft is coupled to said wheel.

10. The pedal system of claim 8, further comprising a crank arm having a first end coupled to said wheel and a second end coupled to said pivot shaft.

11. The pedal system of claim 8, wherein said distance between said foot support surface and said pivot shaft is comparable to the height of a user's ankle.

12. The pedal system of claim 8, wherein said vehicle has only one wheel.

13. The pedal system of claim 12, wherein said one-wheeled vehicle has a seat.

14. The pedal system of claim 12, wherein said one-wheeled vehicle is designed to be ridden by a standing user.
